(19) United States
(12) Patent Application Publication
(10) Pub. No.: US 2024/0419604 A1
(43) Pub. Date: Dec. 19, 2024

(54) GENERATING AND USING A TRANSLATION TABLE THAT ASSOCIATES ATTRIBUTE NAME STRINGS WITH INTEGER VALUES

(71) Applicant: International Business Machines Corporation, Armonk, NY (US)

(72) Inventors: Gabriel Zvi BenHanokh, Tel Aviv (IL); Yuval Lifshitz, Kfar HaOranim (IL)

(21) Appl. No.: 18/211,500

(22) Filed: Jun. 19, 2023

(51) Int. Cl. G06F 12/1027; G06F 12/02

(52) U.S. Cl. CPC G06F 12/1027; G06F 12/0292

(57) ABSTRACT

A computer-implemented method, according to one embodiment, includes generating a translation table. The translation table associates a plurality of attribute name strings with unique integer values. The method further includes outputting information about the translation table to client devices. In response to receiving, from a first of the client devices, a first request that includes a first of the unique integer values, a reply message is generated based on the first unique integer value. The reply message is output to the first client device. A computer program product, according to another embodiment, includes a computer readable storage medium having program instructions embodied therewith. The program instructions are readable and/or executable by a computer to cause the computer to perform the foregoing method.

### BACKGROUND

The present invention relates to attribute name strings used in requests of client devices, and more specifically, this invention relates to generating and using a translation table that associates attribute name strings with integer values.

When defining an extendable application programming interface (API), where clients use client devices to add user-defined attribute names, a common practice includes using strings for attribute names. One example of such an API includes protocols in which all attribute names are defined as open ended strings which thereby allows for new generation of the protocols to add new attribute names without needing to change an existing associated code.

### SUMMARY

A computer-implemented method, according to one embodiment, includes generating a translation table. The translation table associates a plurality of attribute name strings with unique integer values. The method further includes outputting information about the translation table to client devices. In response to receiving, from a first of the client devices, a first request that includes a first of the unique integer values, a reply message is generated based on the first unique integer value. The reply message is output to the first client device.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for generating and using a translation table that associates attribute name strings with integer values.

In one general embodiment, a computer-implemented method, includes generating a translation table. The translation table associates a plurality of attribute name strings with unique integer values. The method further includes outputting information about the translation table to client devices. In response to receiving, from a first of the client devices, a first request that includes a first of the unique integer values, a reply message is generated based on the first unique integer value. The reply message is output to the first client device.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as integer value association code of block 150 for generating and using a translation table that associates attribute name strings with integer values. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

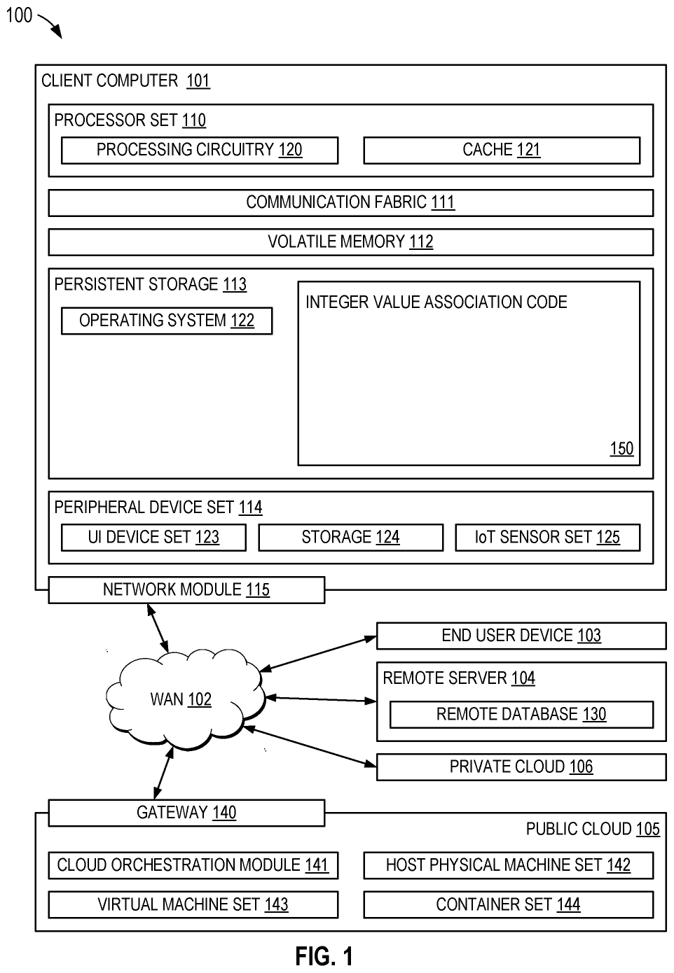

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, when defining an extendable application programming interface (API), a common practice includes using strings for attribute names. One example of such an API includes protocols in which all attribute names are defined as open ended strings which thereby allows for new generation of the protocols to add new attribute names without needing to change an existing associated code.

Conventional API protocols in which all attribute names are defined as open ended strings are inefficient in that strings are relatively expensive to process from a perspective of time, space and other processing resources. More specifically, the relative flexibility of conventional API protocols comes with a relatively high cost as sending/copying/processing long strings consumes relatively more resources than closed protocols, e.g., such as transmission control protocol/internet protocol (TCP/IP) or small computer system interface (SCSI) nonvolatile memory express (NVMe), using fixed offset where the attribute-name is implicitly deduced from the offset. In sharp contrast to the conventional techniques described above, and in order to reduce processing expenses, techniques of embodiments and approaches described herein include creating a dynamic translation table from relatively long strings to fixed-size integers on a table of a server and sharing the table with all client devices. More specifically, these techniques include generating and using a translation table that associates attribute name strings (which may, in some approaches, alternatively be referred to as “field name strings”) with unique integer values. As a result of deploying the translation table, client devices and servers are thereafter able to use unique integer values in requests and replies.

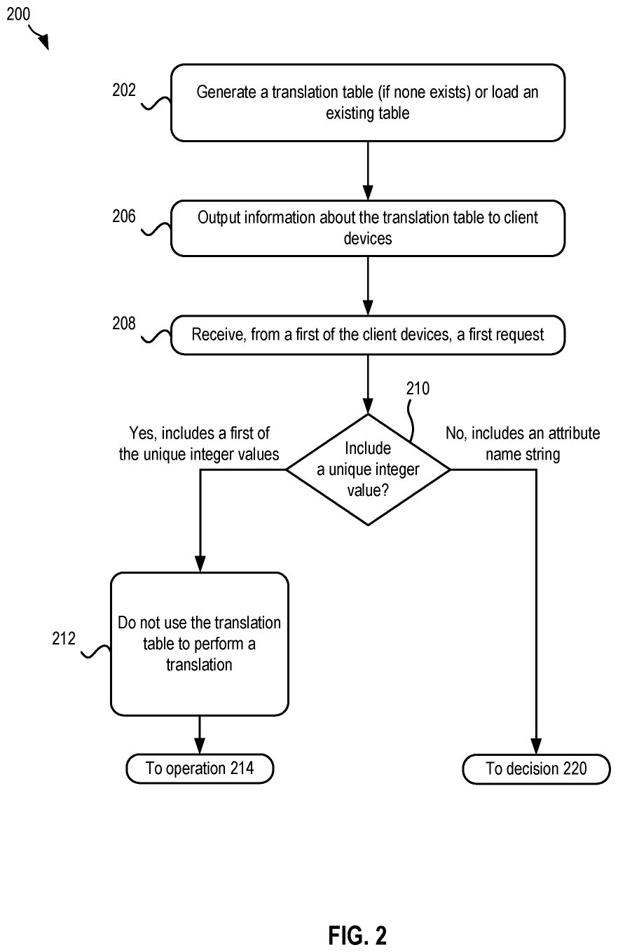

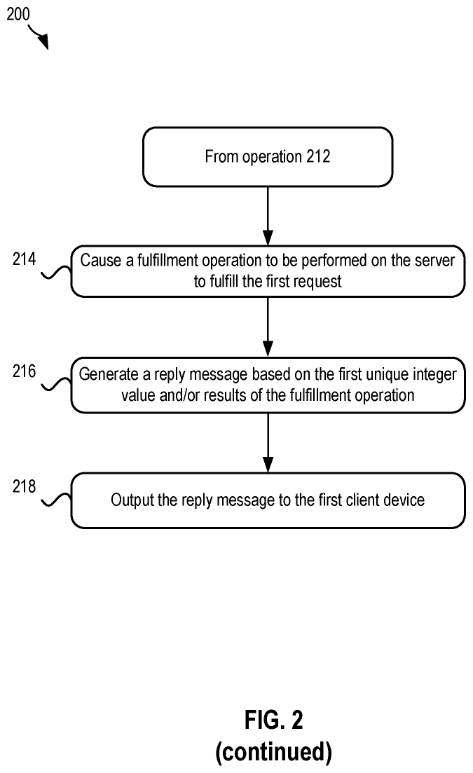

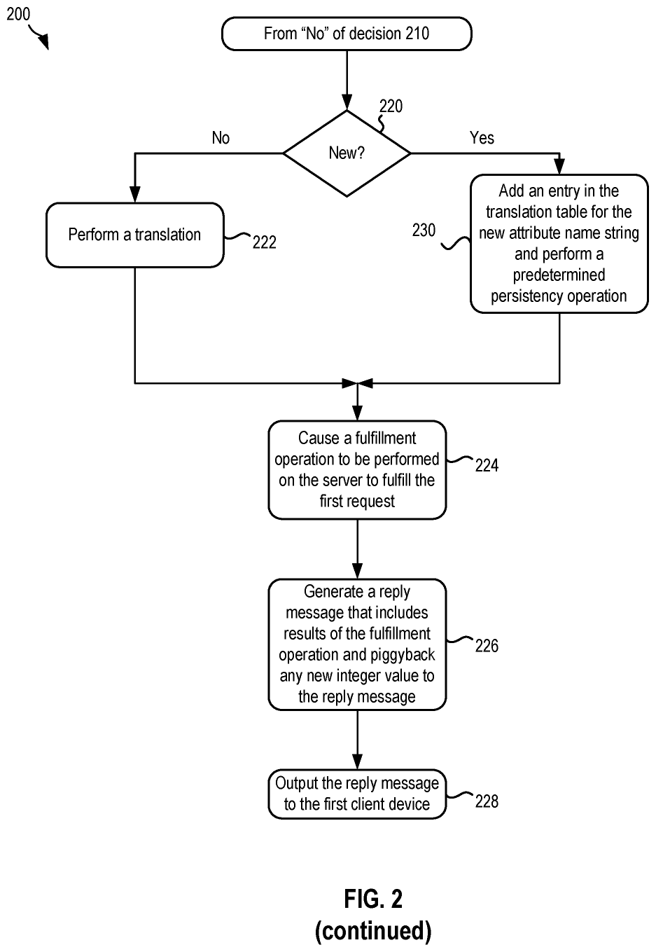

Now referring to FIG. 2, a flowchart of a method 200 is shown according to one embodiment. The method 200 may be performed in accordance with the present invention in any of the environments depicted in FIGS. 1-2, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 may be performed in a network that includes at least one client device, and a server that is configured to communicate with the at least one client device. For example, in some approaches, the server is configured to receive requests from a first client device, selectively perform a fulfillment operation to fulfill the request, and output a reply message to the first client device. The client device may be of a type that would become apparent to one of ordinary skill in the art after reading the descriptions herein, e.g., a computer, a processing circuit, a server, etc. Furthermore, the server may be of a type that would become apparent to one of ordinary skill in the art after reading the descriptions herein.

Operation 202 includes generating a translation table (if none exists). The translation table preferably associates a plurality of attribute name strings with unique integer values. In some approaches, each of the attribute name strings may be associated with a unique integer value in the generated translation table. In some approaches, illustrative attribute names may include, e.g., “content-disposition”, “cache-control”, etc. The integer values may include a predetermined number of bits, e.g., integer values such as 0x17, 0x18, 0x19, etc. Note that, where the translation table otherwise already exists, the existing translation table may be loaded and used, e.g., see operation 202.

In some approaches, the attribute name strings that are incorporated into the translation table are attribute name strings that have previously been received by a server in request(s) from client devices. For context, it may be noted that although, in some typical use cases, there may be near an infinite number of different possible attribute names, in reality a given client may only use hundreds or a few thousand values at the most. However, in other use cases, any number of different possible attribute names may be used, e.g., potentially up to hundreds of thousands in some use cases. This means that a relatively small translation table may be configured to hold all or most of the used values in some use cases. Accordingly, in some approaches, a server may maintain a translation table from strings to an integer holding all or alternatively a majority of commonly used attribute name strings.

It should be noted that although some approaches above detail relatively commonly previously used attribute name strings being incorporated into the translation table, in some other approaches, entries may be ongoingly added to the translation table, e.g., as will be described elsewhere below (see operation 230).

In some approaches, the method 200 may include causing, e.g., instructing, the translation to be stored to a predetermined storage location. Such a location is preferably thereafter accessible by the server, e.g., local on the server, on a predetermined database that is accessible by the server, etc. In some preferred approaches, the server is caused to replace all attribute name strings with integers in all copies of the data that is maintained locally on the server.

Operation 206 includes outputting information about the translation table to client devices. Depending on the approach, the information about the translation table that is output may include, e.g., an indication of at least some of integer values, the entire table, a unique integer value subsequent to receiving a new attribute name string that is not already included in the translation table, only attribute name strings that the client device has historically used, etc. In some approaches, the information about the translation table is output to a predetermined list of client devices that have previously communicated with the server. In some approaches, the information about the translation table is additionally and/or alternatively output to a predetermined list of client devices that have passed a predetermined authentication process. In yet some other approaches, the information about the translation table is output to client devices that request the translation table. For example, in one of such approaches, the information about the translation table is output to the first client device in response to receiving a request for the translation table at a startup of the first client device.

A first request may be received from a first of the client devices, e.g., see operation 208. The first request may be any type of request that would become apparent to one of ordinary skill in the art after reading the descriptions herein. In some preferred approaches, the first request may be a type of request that is configured to include attribute name strings and/or unique integer values. In some approaches, the first request may additionally and/or alternatively be a request for information stored on the server. For example, in one or more of such approaches, the first request may be for a fulfillment operation such as a get, set and/or modify operation to be performed on the server according to specifications included in the first request, e.g., according to attribute name strings and/or unique integer values specified in the first request. Because the first request may include one of the unique integer values in the translation table subsequent to use the translation table being enacted in a network that include the first client device and the server, in some approaches, a determination is made as to whether the first request includes a unique integer value, e.g., see decision 210.

In some approaches, text and/or integer parsing techniques that would become apparent to one of ordinary skill in the art after reading the descriptions herein may be used for determining whether the first request includes a unique integer value. Results of the text and/or integer parsing techniques may be compared with the unique integer values in the translation table to determine whether a match exists. In some approaches, in response to a determination that such a match exists, a determination may be made that the first request includes one of the unique integer values in the translation table, e.g., as illustrated by the “Yes, includes a first of the unique integer values” logical path of decision 210. In some preferred approaches, in response to receiving, from a first of the client devices, a first request that includes a first of the unique integer values, the translation table is not used to perform a translation because the unique integer value is already identified in the first request and thereby known to the server, e.g., see operation 212.

Operation 214 includes causing an operation to be performed to fulfill the first request. The first unique integer value (the integer identifier of the attribute) is preferably used as an identifier by the server to fulfill the request, and the translation table is not accessed at all. In other words, there is no special operation needed by the server and the fulfillment operation, e.g., the requested get/set/modify based on the identifier, is simply caused to be performed. A reply message, which may include at least some results of the fulfillment operation, may be generated and output from the server to the first client device, e.g., see operations 216-218. The reply message may additionally and/or alternatively be based on the first unique integer value. This is because the fulfillment operation is performed by a server based on the first unique integer value.

In some use cases of the techniques described herein, after a cold start, all requests from a client device preferably use integer-identifiers instead of attribute name strings, e.g., a norm after the cold start. In another use case, a mechanism may be deployed to cause the cold start to be skipped by sending the full translation table to the client device(s) on startup.

Referring again to decision 210, in contrast to some approaches described above, a determination may be made that a request received from a client device does not include a unique integer value, in some approaches. For example, the first request may be received from the first client device, a second request may be received from a second client device, a third request may be received from a third client device, etc. In some approaches, a determination may be made as to whether the received request includes an attribute name string, e.g., a first attribute name string, that is not already included in the translation table, e.g., see decision 220. Note that a type of query that would become apparent to one of ordinary skill in the art after reading the descriptions herein may be used for determining whether the translation table already includes the attribute name string. For context, the server preferably maintains a persistent copy of the translation table as without the copy of the translation table, all attribute names lose their meaning. Although cases in which a received request includes an attribute name string that is not already included in the translation table is, in some approaches, likely to be infrequent, in response to a determination that the received request includes an attribute name string that is not already included in the translation table, e.g., as illustrated by the “Yes” logical path of decision 220, one or more operations are preferably performed to persist the string in the translation table. For example, in response to a determination that the request includes a first attribute name string that is not already included in the translation table, a new entry is added in the translation table for the first attribute name string, e.g., see operation 230. A predetermined persistency operation may additionally be performed in some approaches. For example, the predetermined persistency operation may include storing and/or outputting the entry to one or more predetermined locations, as the new entry is preferably to be protected against power-loss. The added entry associates the first attribute name string with a second of the unique integer values. This way, subsequent to the entry being added to the translation table, client devices may include the second unique integer value in requests as opposed to otherwise using the first attribute name string. This thereby reduces an amount of processing that is performed on the server in processing and fulfilling the request because a translation is not performed to determine the second unique integer value. As will be described in greater detail elsewhere below, persisting the new entry may additionally and/or alternatively include informing client devices of the new entry.

The method may continue from operation 230 to optionally include causing a fulfillment operation to be performed on the server to fulfill the received request, e.g., see operation 224. A reply message, which may include at least some results of the fulfillment operation, may be generated and output from the server to the first client device, e.g., see operations 226 and 228. Following a new entry being added in the translation table for a new attribute name string, the new integer value is preferably piggybacked to the reply message, e.g., see operation 226. In order to enable one or more client devices, e.g., such as the first client device, to use the second unique integer value of the entry added to the translation table, in some approaches, method 200 includes outputting an indication of the second unique integer value to one or more client devices, e.g., such as the second client device. In some approaches, an indication of the second unique integer value is output to the second client device in the reply message. Such an indication may include, e.g., the actual second unique integer value, a portion of the second unique integer value, a value that is used to calculate the unique integer values (such as a predetermined number that is added to a most recently used unique integer value), etc. In some preferred approaches, the indication of the second unique integer value is piggybacked on a reply message output to the second client device, e.g., lazy feedback. One or more techniques for piggybacking the second unique integer value to the reply message that would become apparent to one of ordinary skill in the art after reading the descriptions herein may be used.

In some approaches, the outputting of the translation table and/or indications of unique integer values in the translation table may be made based on one or more predetermined flag. For example, in some approaches, the indication of the second unique integer value is output to the second client device in response to a determination that the second client device has set a predetermined flag. In some approaches, the predetermined flag is configured to be optionally set for a period of time that the second client device is capable of caching the translation table. Accordingly, in response to a determination that such a flag is set, the server may be caused to send, e.g., piggybacked on the reply message, the translation for all attribute name strings in a received message to a client device that sent the message. In an alternative approach, in response to a determination that the predetermined flag is clear, the translation information, e.g., the translation table, the unique integer values, etc., is not output to the client device.

Outputting of the translation information, e.g., the translation table, the unique integer values, etc., may additionally and/or alternatively be delayed in some approaches. For example, method 200 may include delaying outputting of an indication of the second unique integer value to the second client device, in response to a determination that the second client device has not set a predetermined flag. In such an approach, the predetermined flag is configured to be optionally set for a period of time that the second client device is capable of caching the translation table. In response to a determination that the second client device has set the predetermined flag, e.g., as determined based on ongoingly checking the flag during the output being delayed, the indication of the second unique integer value may be output to the second client device. In some approaches in which the output of the translation information is delayed, the indication of the second unique integer value is not piggybacked on a reply message output to the second client device because the flag is not set at a time that the reply message is output to the second client device. Accordingly, in some approaches the translation information may be made once a reply message to the second client device is identified, e.g., the translation information is piggybacked to the second client device upon a reply message being sent to the second client device. In some other approaches, the translation information is output to the second client device in an independent message, e.g., not piggybacked to a reply message of a received request.

In some other approaches, method 200 may alternatively include monitoring cache resources of the second client device and only outputting unique integer values and/or the translation table to the second client device in response to a determination that the second client device has at least a predetermined amount of cache resources available. Decision 220 includes determining whether the second request includes at least one of the attribute name strings in the translation table. In some approaches, the request received from the client device may be determined to include a previously used attribute name string, e.g., see “No” logical path of decision 220. In some approaches, because the attribute name string was previously used, the attribute name string may exist in the translation table. In response to a determination that the received request includes such an attribute name string, the server may be caused to not persist the value, as it already exists in the translation table. In response to a determination that the second request includes a second attribute name string in the translation table, the translation table is used to perform a translation, e.g., see operation 222. More specifically, in some preferred approaches, the translation table is preferably used to determine a second unique integer value that is associated with the second attribute name string in the translation table.

With the second unique integer value determined from the translation table, the second unique integer value may be used by the server to fulfill the second request. For example, a fulfillment operation may be caused to, e.g., instructed, be performed using the second unique integer value by the server to fulfill the second request, e.g., see operation 224. For example, the fulfillment operation may include a get, set, modify, etc., operation that is based on the unique integer value. Furthermore, in some approaches, a second reply message is generated based on results of the performed fulfillment operation and output to the second client device, e.g., see operations 226 and 228. The reply message preferably additionally includes returning an indication of the second unique integer value, e.g., to indicate/notify that the client device is to thereafter use the second unique integer value in requests instead of the second attribute name string.

An additional operation of method 200 includes performing a predetermined startup step for the server. The predetermined startup step may include causing, e.g., instructing, the server to restore the translation table from predetermined persistent-storage. In some approaches, the client device may keep a shadow copy of the translation table locally. However, in some approaches, the shadow copy of the translation table is not persisted by the client device, and the client device may always get, e.g., request or be output, an up-to-date copy of the translation table from the server on startup.

Various benefits are enabled by implementing the techniques described herein in networks that include at least one client device and a server. For example, use of the translation table reduces a relative memory footprint on the server side. This reduction in the memory footprint on the server side of the network reduces the amount of data that the server maintains, and therefore the amount of maintenance processing operations performed by the server is relatively reduced. Furthermore, as a result of the client devices being provided the translation table and using the translation table, the client devices use the integer values for attribute names instead of strings. As a result, the size of messages exchanged between client devices and the server are relatively reduced. This relative reduction in message size directly reduces the amount of output that is processed by the client devices and the server as well as directly reduces the size of requests that are processed by the client devices and the server.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a translation table, wherein the translation table associates a plurality of attribute name strings with unique integer values;
outputting information about the translation table to client devices;
in response to receiving, from a first of the client devices, a first request that includes a first of the unique integer values, generating a reply message based on the first unique integer value; and
outputting the reply message to the first client device.

2. The computer-implemented method of claim 1, comprising:
receiving a second request from a second client device;
determining whether the second request includes an attribute name string that is not already included in the translation table; and
in response to a determination that the second request includes a first attribute name string that is not already included in the translation table: adding an entry in the translation table for the first attribute name string, and performing a predetermined persistency operation, wherein the added entry associates the first attribute name string with a second of the unique integer values.

3. The computer-implemented method of claim 2, comprising: outputting an indication of the second unique integer value to the second client device, wherein the indication of the second unique integer value is piggybacked on a reply message output to the second client device.

4. The computer-implemented method of claim 3, wherein the indication of the second unique integer value is output to the second client device in response to a determination that the second client device has set a predetermined flag, wherein the predetermined flag is configured to be optionally set for a period of time that the second client device is capable of caching the translation table.

5. The computer-implemented method of claim 3, comprising: delaying outputting of an indication of the second unique integer value to the second client device, in response to a determination that the second client device has not set a predetermined flag, wherein the predetermined flag is configured to be optionally set for a period of time that the second client device is capable of caching the translation table; and in response to a determination that the second client device has set the predetermined flag, outputting the indication of the second unique integer value to the second client device.

6. The computer-implemented method of claim 1, comprising:
receiving a second request from a second client device;
determining whether the second request includes at least one of the attribute name strings in the translation table; and
in response to a determination that the second request includes a first of the attribute name strings in the translation table: using the translation table to determine a second unique integer value, wherein the second unique integer value is associated with the first attribute name string in the translation table, generating and outputting a second reply message to the second client device based on the determined second unique integer value, and piggybacking the second unique integer value on the second reply message.

7. The computer-implemented method of claim 1, wherein the information about the translation table is output to the first client device in response to receiving a request for the translation table at a startup of the first client device.

8. The computer-implemented method of claim 1, comprising: causing a fulfillment operation to be performed by a server to fulfill the first request, wherein the reply message includes results of the fulfillment operation.

9. A computer program product, the computer program product comprising a computer readable storage medium having program instructions embodied therewith, the program instructions readable and/or executable by a computer to cause the computer to:
generate a translation table, wherein the translation table associates a plurality of attribute name strings with unique integer values;
output information about the translation table to client devices;
in response to receiving, from a first of the client devices, a first request that includes a first of the unique integer values, generate a reply message based on the first unique integer value; and
output the reply message to the first client device.

10. The computer program product of claim 9, the program instructions readable and/or executable by the computer to cause the computer to:
receive a second request from a second client device;
determine whether the second request includes an attribute name string that is not already included in the translation table; and
in response to a determination that the second request includes a first attribute name string that is not already included in the translation table: add an entry in the translation table for the first attribute name string, and perform a predetermined persistency operation, wherein the added entry associates the first attribute name string with a second of the unique integer values.

11. The computer program product of claim 10, the program instructions readable and/or executable by the computer to cause the computer to: output an indication of the second unique integer value to the second client device, wherein the indication of the second unique integer value is piggybacked on a reply message output to the second client device.

12. The computer program product of claim 11, wherein the indication of the second unique integer value is output to the second client device in response to a determination that the second client device has set a predetermined flag, wherein the predetermined flag is configured to be optionally set for a period of time that the second client device is capable of caching the translation table.

13. The computer program product of claim 11, the program instructions readable and/or executable by the computer to cause the computer to: delay outputting of an indication of the second unique integer value to the second client device, in response to a determination that the second client device has not set a predetermined flag, wherein the predetermined flag is configured to be optionally set for a period of time that the second client device is capable of caching the translation table; and in response to a determination that the second client device has set the predetermined flag, output the indication of the second unique integer value to the second client device.

14. The computer program product of claim 9, the program instructions readable and/or executable by the computer to cause the computer to:
receive a second request from a second client device;
determine whether the second request includes at least one of the attribute name strings in the translation table; and
in response to a determination that the second request includes a first of the attribute name strings in the translation table: use the translation table to determine a second unique integer value, wherein the second unique integer value is associated with the first attribute name string in the translation table, generate and output a second reply message to the second client device based on the determined second unique integer value, and piggyback the second unique integer value on the second reply message.

15. The computer program product of claim 9, wherein the information about the translation table is output to the first client device in response to receiving a request for the translation table at a startup of the first client device.

16. The computer program product of claim 9, the program instructions readable and/or executable by the computer to cause the computer to: cause a fulfillment operation to be performed by a server to fulfill the first request, wherein the reply message includes results of the fulfillment operation.

17. A system, comprising:
a processor; and
logic integrated with the processor, executable by the processor, or integrated with and executable by the processor, the logic being configured to:
generate a translation table, wherein the translation table associates a plurality of attribute name strings with unique integer values;
output information about the translation table to client devices;
in response to receiving, from a first of the client devices, a first request that includes a first of the unique integer values, generate a reply message based on the first unique integer value; and
output the reply message to the first client device.

18. The system of claim 17, the logic being configured to:
receive a second request from a second client device;
determine whether the second request includes an attribute name string that is not already included in the translation table; and
in response to a determination that the second request includes a first attribute name string that is not already included in the translation table: add an entry in the translation table for the first attribute name string, and perform a predetermined persistency operation, wherein the added entry associates the first attribute name string with a second of the unique integer values.

19. The system of claim 18, the logic being configured to: output an indication of the second unique integer value to the second client device, wherein the indication of the second unique integer value is piggybacked on a reply message output to the second client device.

20. The system of claim 19, wherein the indication of the second unique integer value is output to the second client device in response to a determination that the second client device has set a predetermined flag, wherein the predetermined flag is configured to be optionally set for a period of time that the second client device is capable of caching the translation table.
